(19) United States
(12) Patent Application Publication
(10) Pub. No.: US 2008/0227315 A1
(43) Pub. Date: Sep. 18, 2008

(54) Terminal and connecting structure between terminal and board

(76) Inventors: Shigeki Banno, Chiryu-shi (JP); Takahiro Naganuma, Kariya-shi (JP); Koji Yanai, Kariya-shi (JP)

Correspondence Address: BUCHANAN, INGERSOLL & ROONEY PC, POST OFFICE BOX 1404, ALEXANDRIA, VA, 22313-1404, US

(21) Appl. No.: 12/076,171

(22) Filed: Mar. 14, 2008

(30) Foreign Application Priority Data
Mar. 16, 2007 (JP) 2007-068043
Dec. 25, 2007 (JP) 2007-331949

(51) Int. Cl. H01R 12/00

(52) U.S. Cl. 439/82

(57) ABSTRACT

A terminal adapted to be inserted into a through-hole of a board from an insertion end and electrically connected to the board, includes a body portion in a cylindrical shape, a first retaining portion outwardly extending from the body portion so as to be elastically deformable in a perpendicular direction relative to an axial direction of the body portion and contacting a first surface of the board or a boundary portion between the first surface and the through-hole, and a second retaining portion positioned at a counter-insertion end side relative to the first retaining portion, outwardly protruding from the body portion and contacting a second surface, which is an opposite surface of the first surface, or a boundary portion between the second surface and the through-hole.

### CROSS REFERENCE TO RELATED APPLICATIONS

This application is based on and claims priority under 35 U.S.C. §119 to Japanese Patent Application 2007-068043, filed on Mar. 16, 2007, and Japanese Patent Application 2007-331949, filed on Dec. 25, 2007, the entire contents of which are incorporated herein by reference.

### FIELD OF THE INVENTION

The present invention relates to a terminal inserted into a through-hole of a board so as to be electrically connected to the board, and a connecting structure between the terminal and the board.

### BACKGROUND

A press-fit terminal press-fitted into a through-hole formed on a board and electrically connected to a conductive member of the board is known.

A press-fit terminal disclosed in JP2004127610A is formed to have an introducing portion whose sectional area is set to be smaller than a sectional area of a retaining portion in order to decrease an elasticity of the introducing portion than an elasticity of the retaining portion and further, in order to decrease stress applied to a board when the press-fit terminal is press-fitted into a through-hole.

According to a press-fit terminal disclosed in JP2005226089A, a tin-plating (conductive member) whose thickness is set to be any desired thickness is applied to the press-fit terminal in order to prevent the tin plate from being scratched off when the press-fit terminal is press-fitted into a through-hole.

According to a press-fit terminal disclosed in JP2004134301A, a press-in jig is used in order to reduce a stress applied to a board when a press-fit terminal is press fitted into a through-hole.

However, any of the press-fit terminals disclosed in JP2004127610A, JP2005226089A and JP2004134301A do not sufficiently prevent the press-fit terminal from being scratched off when a press-fitting force is set to a level by which current is sufficiently transmitted between the press-fit terminal and the conductive member of the board. Further, the press-fit terminals of the known arts are not suitable to be adapted to a board having a low rigidity, for example a multi-layered board, because the stress is generated on the board during and after the press-fit terminal is press-fitted into the through-hole. According to the known terminal disclosed in JP2004134301, the press-in jig is used for press-fitting the terminal into the through-hole. Further, the press-in jig needs to be preliminarily inserted into the through-hole for a predetermined depth. As a result, the number of components is increased, and insertion depth of the press-in jig needs to be controlled.

A need thus exists to provide a terminal and a connecting structure between the terminal and a board, which are not susceptible to the drawback mentioned above.

### SUMMARY OF THE INVENTION

According to an aspect of the present invention, a terminal adapted to be inserted into a through-hole of a board from an insertion end and electrically connected to the board, includes a body portion in a cylindrical shape, a first retaining portion outwardly extending from the body portion so as to be elastically deformable in a perpendicular direction relative to an axial direction of the body portion and contacting a first surface of the board or a boundary portion between the first surface and the through-hole, and a second retaining portion positioned at a counter-insertion end side relative to the first retaining portion, outwardly protruding from the body portion and contacting a second surface or a boundary portion between the second surface and the through-hole.

According to another aspect of the present invention, a connecting structure between a terminal and a board includes a board having a through-hole and a conductive member provided at an inner surface of the through-hole, a terminal inserted into the through-hole from an insertion end and electrically connected to the conductive member, a countersunk portion formed on the through-hole at an entrance side into which the terminal inserted and having an inner diameter increasing towards the entrance side, wherein the terminal includes a first retaining portion outwardly extending from the body portion so as to be elastically deformable in a perpendicular direction relative to an axial direction of the body portion and contacting a first surface of the board or a boundary portion between the first surface of the board opposite from the second to which the entrance is formed, and a conical terminal portion positioned at a counter-insertion end side relative to the first retaining portion and enlarged from the insertion end to the counter-insertion end in a conical manner and contacting the countersunk portion via their surfaces.

### BRIEF DESCRIPTION OF THE DRAWINGS

The foregoing and additional features and characteristics of the present invention will become more apparent from the following detailed description considered with the reference to the accompanying drawings, wherein:

FIG. 1 is a cross-sectional view illustrating a state where a terminal related to a first embodiment is assembled to a board;

FIG. 2 is a cross-sectional view illustrating a state where a terminal related to a second embodiment is assembled to the board;

FIG. 3 is a partial cross-sectional view illustrating a state where a terminal related to a third embodiment is assembled to the board;

FIG. 4 is a partial cross-sectional view illustrating a state where a terminal related to a fourth embodiment is assembled to the board;

FIG. 5 is a partial cross-sectional view illustrating a state where a terminal related to a fifth embodiment is assembled to the board;

FIG. 6 is a partial cross-sectional view illustrating a state where a terminal related to a sixth embodiment is assembled to the board;

FIG. 7 is a partial cross-sectional view illustrating a state where a terminal related to a seventh embodiment is assembled to the board;

FIG. 8 is a partial cross-sectional view illustrating a state where a terminal related to an eighth embodiment is assembled to the board;

FIG. 9 is a partial cross-sectional view illustrating a state where a terminal related to a ninth embodiment is assembled to the board; and

FIG. 10 is a partial cross-sectional view illustrating a state where a terminal related to a tenth embodiment is assembled to the board.

### DETAILED DESCRIPTION

### First Embodiment

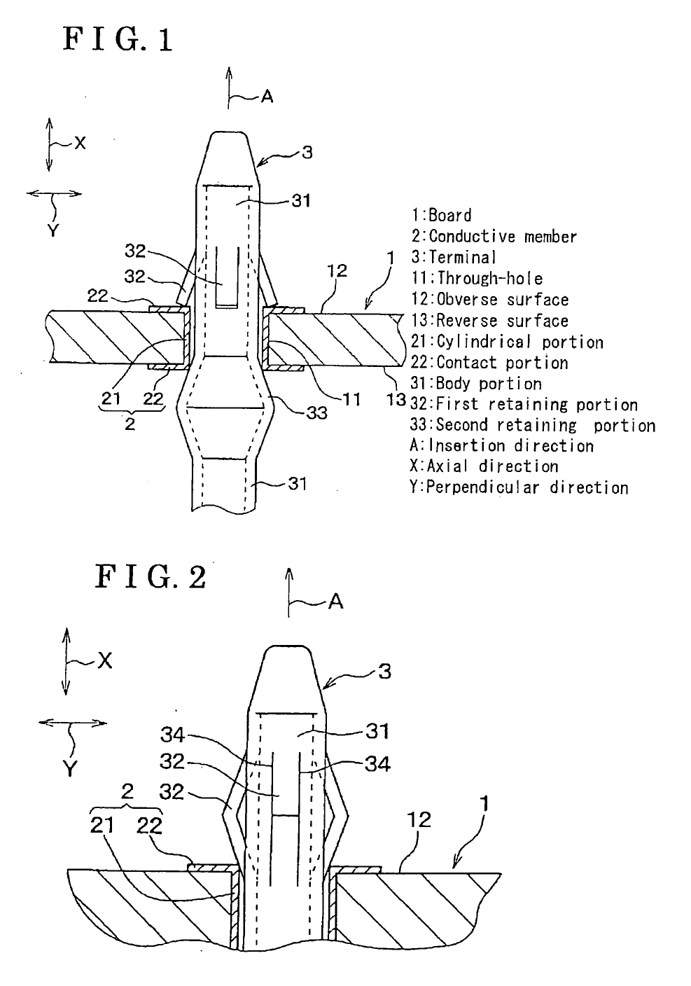

A first embodiment of the present invention is described below. FIG. 1 is a cross-sectional view illustrating a state where a terminal related to the first embodiment is assembled to a board.

As illustrated in FIG. 1, a conductive member 2 made of copper foil is attached at a through-hole 11 of a board 1. The conductive member 2 includes a cylindrical portion 21 covering an inner circumference of the through-hole 21 and contact portions 22 extending from both ends of the cylindrical portion 21 along an obverse surface 12 (first surface) and a reverse surface 13 (second surface) of the board 1. The obverse surface is a surface formed at an upper portion of the board in FIGS. 1 to 10, and the reverse surface is a surface formed at a lower portion of the board in FIGS. A terminal 3 is inserted into the through-hole 11 of the board. 1 from its front end portion in an insertion direction A (i.e., an insertion end of the terminal 3) toward the insertion direction A. As a result, the conductive member 2 and the terminal 3 are electrically connected, and further, the terminal 3 is integrated with the board 1.

The terminal 3 is formed by pressing a plate made of, for example, copper foil, brass and the like. The terminal 3 includes a body portion 31 formed in a cylindrical shape, four first retaining portions 32 formed in portions of the body portion 31, and a second retaining portion 33. The body portion 31 is formed to have a smaller inner diameter than an inner diameter of the cylindrical portion 21 of the conductive member 2. The insertion end of the terminal 3 is formed in a tapered shape in which a diameter of the insertion end is enlarged towards a counter-insertion end of the terminal 3 so that the terminal 3 is easily inserted into the through-hole 11 of the board 1.

Each of the first retaining portions 32 is a plate spring integrally formed with the body portion 31. Specifically, each of the first retaining portions 32 includes a free end at one side thereof so as to form a protruding piece. More specifically, each of the first retaining portions 32 extends along an axial direction X of the body portion 31 (herein after referred to simply as an axial direction X), and further, each of the first retaining portions 32 includes a fixed end thereof in the insertion direction A whereby the first retaining portions 32 being connected to the body portion 31. Further, each of the first retaining potions 32 includes the free end at the other end (i.e., an end portion opposite from the inserting end of the terminal 3) of each of the first retaining portions 32 spaced away from the body portion 31 so that each of the first retaining portions 32 is elastically deformable in a direction Y perpendicular to the axial direction X (hereinafter referred to simply as a perpendicular direction Y) with the fixed end as a base point. Each of the first retaining portions 32 is bent at the fixed end so that the free end of each of the first retaining portions 32 outwardly downwardly protrudes in the perpendicular direction Y when each of the first retaining portions 32 is in a free state. Further, the first retaining portions 32 are provided at the body portion 31 along a circumferential direction thereof so as to be equally spaced from each other.

The second retaining portion 33 is positioned lower than the first retaining portions 32 in a direction opposite from the insertion direction A in FIG. 1. A diameter of the second retaining portion 33 is enlarged towards the counter-insertion end in a conical manner, and then, the diameter of the second retaining portion 33 is narrowed towards the counter-insertion end in the conical manner. Additionally, a greatest outer diameter of the second retaining portion 33 is set to be larger than the inner diameter of the cylindrical portion 21 of the conductive member 2.

In the above-mentioned configuration, when the terminal 3 is inserted into the through-hole 11 of the board 1, that is to say, when the terminal 3 is inserted into the cylindrical portion 21 of the conductive member 2, the first retaining portions 32 are elastically inwardly deformed in the perpendicular direction Y, and then, the terminal 3 proceeds through the cylindrical portion 21 with the first retaining portions 32 sliding the inner circumference of the cylindrical portion 21.

The first retaining portions 32 are outwardly spread in the perpendicular direction Y by its resilience after the first retaining portions 32 pass through the cylindrical portion 21. Then, the first retaining portions 32 are engaged with an obverse surface 12 of the board 1, more specifically, the first retaining portions 32 are engaged with the contact portion 22 of the conductive member 2. Further, when the first retaining portions 32 pass through the cylindrical portion 21, the second retaining portion 33 contacts a reverse surface 13 of the board 1, more specifically, the second retaining portion 33 contacts the conductive member 2 at a boundary portion between the cylindrical portion 21 and the contact portion 22. As a result, the board 1 is held by the first retaining portions 32 and the second retaining portion 33. Further, because the first retaining portions 32 contact the contact portion 22 of the conductive member 2 and the second retaining portion 33 contacts the conductive member 2 at the boundary portion between the cylindrical portion 21 and the contact portion 22, the board 1 and the terminal 3 are electrically connected.

According to the above-mentioned first embodiment, the first retaining portions 32 are elastically deformed while proceeding through the cylindrical portion 21, in other words, the first retaining portions 32 do not generate as large pressing force as a case where the terminal 3 is press-fitted to the board 1. Hence, an amount of the conductive member 2 being scratched off is considerably decreased.

Furthermore, stress, generated at the board 1 during and after the terminal 3 is assembled to the board 1, is decreased. Therefore, the terminal 1 of the first embodiment is easily applicable to a multi-layered board having a low rigidity.

Further, according to the terminal 1 of the first embodiment, use of a press-in jig and an operation for inserting the press-in jig are eliminated. Hence, the number of components is reduced, and further, the operation for inserting the press-fit jig is not needed.

Current is securely transmitted between the terminal 3 and the conductive member 2 because of spring effects of the first retaining portions 32. Further, a relative displacement (e.g., backlash) between the terminal 3 and the board 1 in the axial direction X is prevented by the spring effects of the first retaining portions 32. Specifically, because the terminal 1 of the first embodiment includes the plural first retaining portions 32, current is securely transmitted between the terminal 3 and the conductive member 2, and furthermore, the relative displacement between the terminal 3 and the board 1 is securely prevented.

Comparing to a terminal 1 of a second embodiment (see FIG. 2) to be described below having a first retaining portion 32 whose both ends are connected to the body portion 31, the first retaining portions 32 of the first embodiment are easily elastically deformable. Therefore, the first retaining portions 32 of the first embodiment easily pass through the cylindrical portion 21. Further, the free ends of the first retaining portions 32 are engaged with the obverse surface 12 of the board 1 after the terminal 3 is assembled thereto. As a result, the first retaining portions 32 of the first embodiment securely prevent the terminal 3 from being disengaged from the board 1.

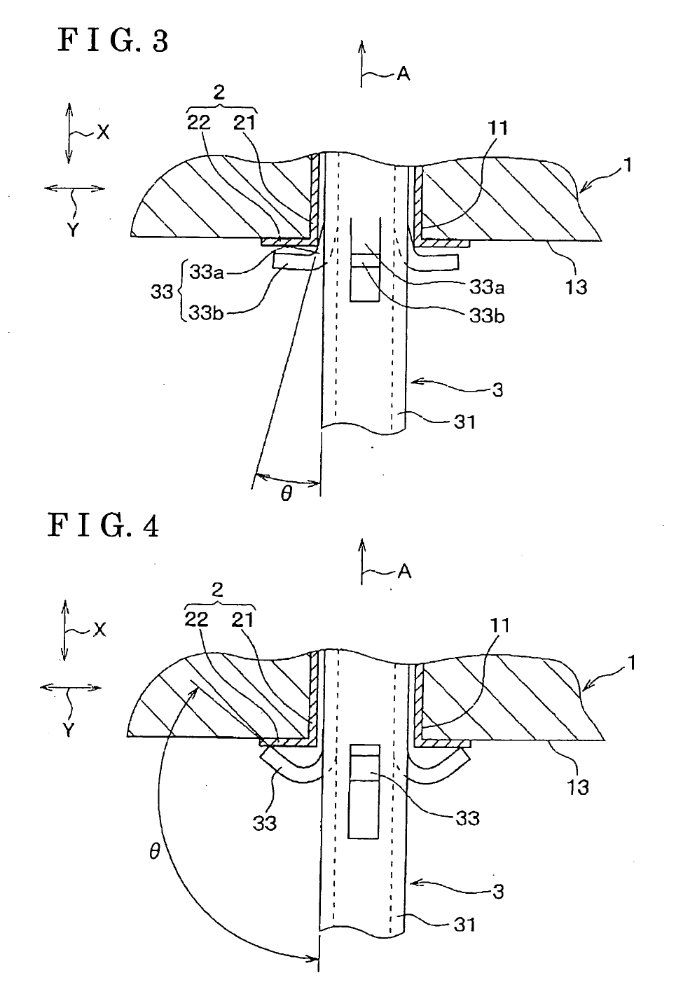

Comparing to a terminal 1 of a sixth embodiment (see FIG. 6) to be described below having a second retaining portion 33 formed between two slits 34, and comparing to a terminal of a third embodiment (see FIG. 3) to be described below including a second retaining portion 33 having a free end at one end thereof in order to form a protruding piece, the second retaining portion 33 of the first embodiment has a greater rigidity. Hence, even if the board 1 is pressed with a large force towards the second retaining portion 33, the board 1 is securely held between the first retaining portions 32 and the second retaining portion 33 of the first embodiment. In other words, the second retaining portion 33 securely receives the board 1.

According to the first embodiment, the second retaining portion 33 contacts the conductive member 2 at the boundary portion between the cylindrical portion 21 and the contact portion 22 of the conductive member 2. Therefore, the diameter of the contact portion extending along the reverse surface of the board 1 may be decreased. Further, the relative displacement (e.g., backlash) between the board 1 and the terminal 3 in the perpendicular direction Y may be prevented.

According to the first embodiment, the body portion 31 is formed to have the smaller inner diameter than the inner diameter of the cylindrical portion 21. Hence, the body portion 31 is freely retained within the cylindrical portion 21 so as not to contact an inner surface thereof. In other words, a clearance is formed between the body portion 31 and the inner circumference of the cylindrical portion 21. Therefore, the body portion 31 is retained within the cylindrical portion 21 with play. As a result, the stress is prevented from generating on the inner circumference of the through-hole 11 after the terminal 3 is assembled to the board 1, and further, the stress generated at the board 1 is reduced.

### Second Embodiment

The second embodiment of the present invention will be described below. FIG. 2 is a cross-sectional view illustrating a state where a terminal related to the second embodiment is assembled to the board.

In the second embodiment, a modified structure of the first retaining portions 32 according to the first embodiment will be described. The identical reference numerals denote identical or corresponding parts of the first embodiment, and detailed explanation of those will be omitted.

As illustrated in FIG. 2, each of first retaining portions 32 of the second embodiment is made of a plate spring integrally formed with the body portion 31. Each of the first retaining portions 32 is formed between the two slits 34 extending in parallel along the axial direction X. Further, both ends of the first retaining portion 32 at an insertion end side and a counter-insertion end side are connected to the body portion 31. Each of the both ends at the insertion end side and the counter-insertion end side serves as a fixed end.

Each of the first retaining portions 32 is bent at both fixed portions and at a intermediate portion thereof in the axial direction X so as to form an angular bracket-shape. As a result, each of the first retaining portions 32 is elastically deformable in the perpendicular direction Y. More specifically, when each of the first retaining portions 32 is in a free state, the intermediate portion thereof in the axial direction X outwardly protrudes in the perpendicular direction Y so as to form a clearance between the first retaining portions 32 and the body portion 31, and further, an outer circumference of each of the first retaining portions 32 at the intermediate portion in the axial direction X protrudes outwardly greater than the inner circumference of the cylindrical portion 21 of the conductive member 2 in the perpendicular direction Y.

In the second embodiment, when the terminal 3 is inserted into the through hole 22 of the board 1, the first retaining portions 32 are elastically inwardly deformed in the perpendicular direction Y, and then terminal 3 proceeds through the cylindrical portion 21 with the first retaining portions 32 sliding the inner circumference of the cylindrical portion 21.

After the intermediate portions (the most protruding portions) of the first retaining portions 32 in the axial direction X pass through the cylindrical portion 21, the first retaining portions 32 outwardly spread in the perpendicular direction Y by the resilience. As a result, the first retaining portions 32 engage with the obverse surface 12 of the board 1. More specifically, the first retaining portions 32 contact the boundary portion between the cylindrical portion 21 and the contact portion 22 of the conductive member 2.

According to the second embodiment, a level of spring forces of the first retaining portions 32 may be set to any desired level by adjusting the length of the slits 34.

Further, according to the second embodiment, the first retaining portions 32 contact the conductive member 2 at the boundary portion between the cylindrical portion 21 and the contact portion 22 of the conductive member 2, a diameter of the contact portion 22 extending along the obverse surface 12 of the board 1 may be decreased.

### Third Embodiment

The third embodiment of the present invention will be described below. FIG. 3 is a cross-sectional view illustrating a state where a terminal related to the third embodiment is assembled to the board.

In the third embodiment, a modified structure of the second retaining portion 33 according to the first embodiment will be described. The identical reference numerals denote identical or corresponding parts of the first embodiment, and detailed explanation of those will be omitted.

As illustrated in FIG. 3, a second retaining portion 33 is made of a plate spring integrally formed with the body portion 31. More specifically, the second retaining portion 33 includes a free end at one side thereof in order to form a protruding piece. In particular, the second retaining portion 33 includes a fixed end connected to the body portion 31 at the insertion end side of the body portion 31 and a free end at the counter-insertion end side. The free end of the second retaining portion 33 is spaced away from the body portion 31. In the third embodiment, the body portion 31 includes four second retaining portions 33 that are equally spaced away from each other along the circumferential direction of the body portion 31.

Each of the second retaining portions 33 is bent at the fixed end and an intermediate portion thereof. A first bent portion 33a formed by bending each of the second retaining portions 33 at the fixed end is formed to outwardly incline toward the counter-insertion end side in the perpendicular direction Y. A bending angle θ of the first bent portion 33a of each of the second retaining portions 33 relative to the axial direction X is set to form an acute angle (e.g., approximately 15 degrees) so that the first bent portion 33a contacts the boundary portion between the cylindrical portion 21 and the contact portion 22 of the conductive member 2.

A second bent portion 33b is formed at the body portion 31 so as to be spaced away from the first bent portion 33a in an opposite direction from the insertion direction A. Further, the second bent portion 33b is formed so as to extend substantially parallel to the reverse surface 13 of the board 1 when the terminal 3 is assembled to the board 1.

According to the third embodiment, the first bent portions 33a of the second retaining portions 33 engage with the reverse surface 13 of the board 1. As a result, the board 1 is held by the first retaining portions 32 and the first bent portions 33a of the second retaining portions 33. Further, spring effects of the second retaining portions 33 secure current transmission between the terminal 3 and the conductive member 2. Moreover, the relative displacement between the board 1 and the terminal 3 in the axial direction X is prevented.

According to the third embodiment, the second retaining portions 33 contact the conductive member 2 at the boundary portion between the cylindrical portion 21 and the contact portion 22 of the conductive member 2. Therefore, the diameter of the contact member 22 extending along the reverse surface 13 of the board 1 may be decreased.

### Fourth Embodiment

A fourth embodiment of the present invention will be described below. FIG. 4 is a cross-sectional view illustrating a state where a terminal related to the fourth embodiment is assembled to the board.

In the fourth embodiment, a modified structure of the second retaining portion 33 according to the first embodiment will be described. The identical reference numerals denote identical or corresponding parts of the first embodiment, and detailed explanation of those will be omitted.

As illustrated in FIG. 4, a second retaining portion 33 of the fourth embodiment is made of a plate spring integrally formed with the body portion 31. More specifically, the second retaining portion 33 includes a free end at one side thereof in order to form a protruding piece. In particular, the second retaining portion 33 includes a fixed end connected to the body portion 31 at the insertion end side of the body portion 31 and a free end at the counter-insertion end side. The free end of the second retaining portion 33 is spaced away from the body portion 31. In the fourth embodiment, the body portion 31 includes four second retaining portions 33 that are equally spaced away from each other along the circumferential direction of the body portion 31.

Each of the second retaining portions 33 is formed to be outwardly inclined toward the counter-insertion end side from the fixed portion in the perpendicular direction Y. A bending angle θ of each of the second retaining portions 33 in vicinity of the free end side relative to the axial direction X is set to form an obtuse angle (e.g., approximately 120 degrees) so that the free end of each of the second retaining portions 33 contacts the contact portion 22 of the conductive member 2.

According to the fourth embodiment, the free ends of the second retaining portions 33 engage with the reverse surface 13 of the board 1. As a result, the board 1 is held by the first retaining portions 32 and the second retaining portions 33. Further, spring effects of the second retaining portions 33 secure current transmission between the terminal 3 and the conductive member 2. Moreover, the relative displacement between the board 1 and the terminal 3 in the axial direction X is prevented.

Further, because the free ends of the second retaining portions 33 engage with the reverse surface 13 of the board 1, the entire second retaining portions 33 from its fixed ends to the free ends are deformed. As a result, concentration of the stress on the fixed ends is prevented from occurring.

### Fifth Embodiment

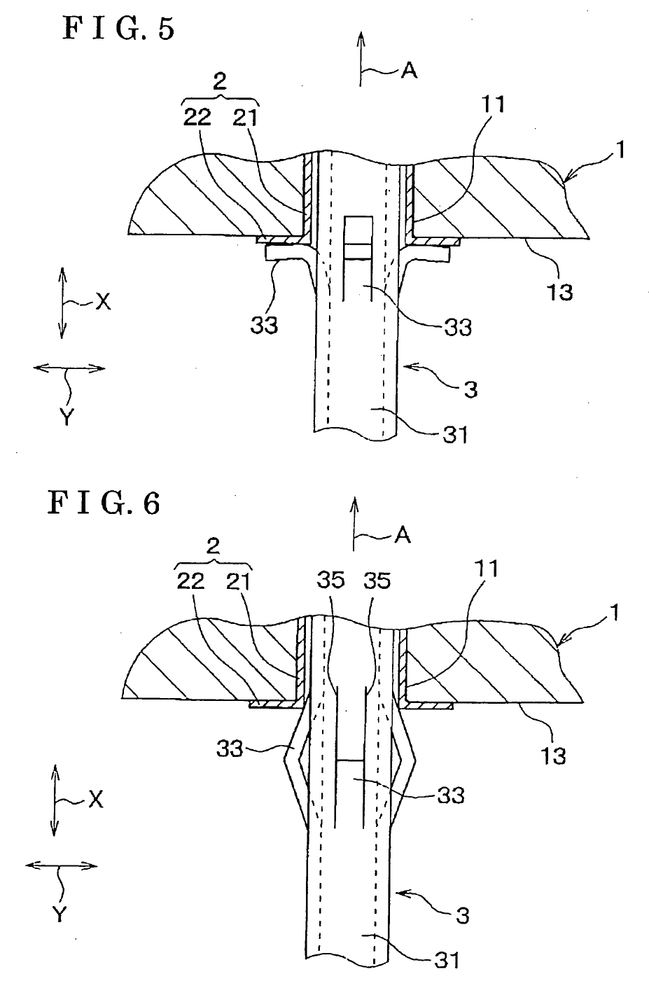

A fifth embodiment of the present invention will be described below. FIG. 5 is a cross-sectional view illustrating a state where a terminal related to the fifth embodiment is assembled to the board.

In the fifth embodiment, a modified structure of the second retaining portion 33 according to the first embodiment will be described. The identical reference numerals denote identical or corresponding parts of the first embodiment, and detailed explanation of those will be omitted.

As illustrated in FIG. 5, a second retaining portion 33 of the fifth embodiment is made of a plate spring integrally formed with the body portion 31. More specifically, the second retaining portion 33 includes a free end at one side thereof in order to form a protruding piece. In particular, the second retaining portion 33 includes a fixed end connected to the body portion 31 at the counter-insertion end side of the body portion 31 and a free end at the insertion end side. The free end of the second retaining portion 33 is spaced away from the body portion 31. In the fifth embodiment, the body portion 31 includes four second retaining portions 33 that are equally spaced away from each other along the circumferential direction of the body portion 31.

Each of the second retaining portions 33 is formed to be outwardly inclined towards the counter-insertion end from the fixed portion in the perpendicular direction Y. Each of the second retaining portions 33 at the free ends forms a flat plate-shape. Further, each of the second retaining portions 33 is bent substantially in parallel to the reverse surface 13 of the board 1 so that the flat-plate portion of each of the second retaining portions 33 at the free end side contacts the contact portion 22 of the conductive member 2.

According to the fifth embodiment, the free ends of the second retaining portions 33 engage with the reverse surface 13 of the board 1. As a result, the board 1 is held by the first retaining portions 32 and the second retaining portions 33. Further, spring effects of the second retaining portions 33 secure current transmission between the terminal 3 and the conductive member 2. Moreover, the relative displacement between the board 1 and the terminal 3 in the axial direction X is prevented.

According to the fifth embodiment, the second retaining portions 33 include fixed portions connected to the body portion 13 at the counter-insertion end side. Therefore, length of the second retaining portions 33 can be adjusted to any desired length while avoiding contact with the first retaining portions 32. Hence, the spring forces of the second retaining portions 33 may be easily set to any desired level, and further, the second retaining portions 33 are easily modified so as to increase contact areas between the second retaining portions 33 and the conductive member 2.

### Sixth Embodiment

The sixth embodiment of the present invention will be described below. FIG. 6 is a cross-sectional view illustrating a state where a terminal related to the sixth embodiment is assembled to the board.

In the sixth embodiment, a modified structure of the second retaining portion 33 according to the first embodiment will be described. The identical reference numerals denote identical or corresponding parts of the first embodiment, and detailed explanation of those will be omitted.

As illustrated in FIG. 6, a second retaining portion 33 of the sixth embodiment is made of a plate spring integrally formed with the body portion 31. More specifically, the second retaining portion 33 is formed between two parallel slits 35 extending along the axial direction X, and both ends of the second retaining portion 33 at the insertion end side and the counter-insertion end side are connected to the body portion 31. In the sixth embodiment, the body portion 31 includes four second retaining portions 33 that are equally spaced away from each other along the circumferential direction of the body portion 31.

Each of the second retaining portions 33 is bent at both fixed portions and at a intermediate portion thereof in the axial direction X so as to form an angular bracket-shape. Hence, each of the second retaining portions 33 is elastically deformable in the perpendicular direction Y. More specifically, when each of the second retaining portions 33 is in a free state, the intermediate portion thereof in the axial direction X outwardly protrude in the perpendicular direction Y so as to form a clearance between the second retaining portion 33 and the body portion 31, and further, an outer circumference of each of the second retaining portions 33 at the intermediate portion in the axial direction X protrudes outwardly greater than the inner circumference of the cylindrical portion 21 of the conductive member 2 in the perpendicular direction Y.

The second retaining portions 33 contact the reverse surface 13 of the board 1. More specifically, the second retaining portions 33 contact the boundary portion between the cylindrical portion 21 and the contact portion 22 of the conductive member 2. As a result, the board 1 is held by the first retaining portions 32 and the second retaining portions 33.

According to the sixth embodiment, spring forces of the second retaining portions 33 may be set to any desired level by adjusting the length of the slits 35.

Further, the second retaining portions 33 contact the conductive member 2 at the boundary portion between the cylindrical portion 21 and the contact portion 22 of the conductive member 2. As a result, the diameter of the contact portion 22 extending along the reverse surface 13 of the board 1 may be decreased.

### Seventh Embodiment

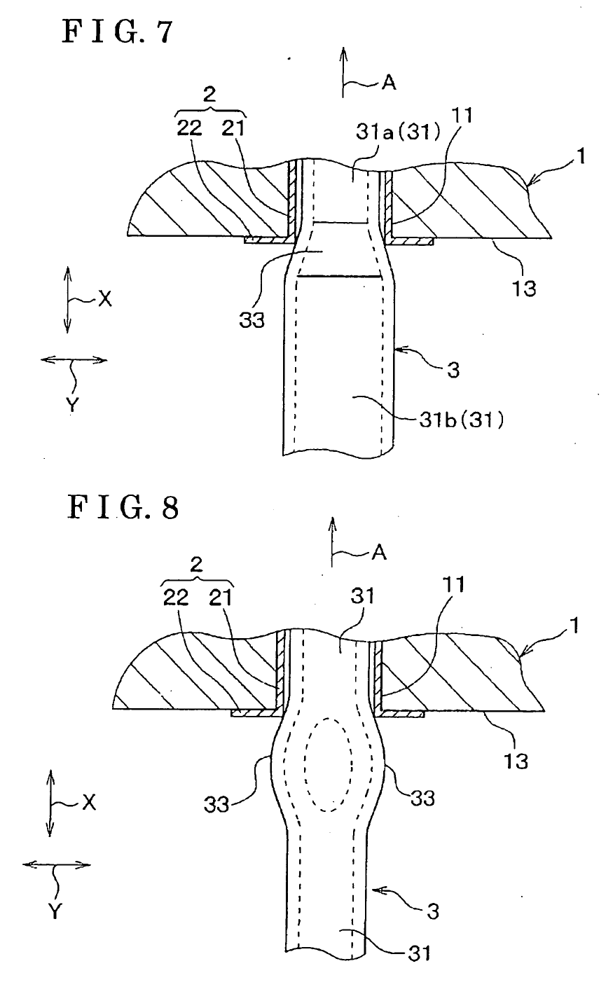

A seventh embodiment of the present invention will be described below. FIG. 7 is a cross-sectional view illustrating a state where a terminal related to the seventh embodiment is assembled to the board.

In the seventh embodiment, a modified structure of the second retaining portion 33 according to the first embodiment will be described. The identical reference numerals denote identical or corresponding parts of the first embodiment, and detailed explanation of those will be omitted.

As illustrated in FIG. 7, a terminal 3 of the seventh embodiment includes a first body portion 31a formed in a cylindrical shape, a second body portion 31b formed in a cylindrical shape, and a second retaining portion 33. The first body portion 31a is formed at the insertion end side. The second body portion 31b having a larger diameter than the first body portion 31a is formed lower than the first body portion 31a in an opposite direction from the insertion direction A in FIG. 7. The second retaining portion 33 is formed between the first and the second body portions 31a and 31b.

A diameter of the second retaining portion 33 is enlarged towards the counter-insertion end side in a conical manner. The greatest diameter of the second retaining portion 33 is set to be larger than the inner diameter of the cylindrical portion 21 of the conductive member 2. Hence, the second retaining portion 33 contacts the reverse surface 13 of the board 1. More specifically, the second retaining portion 33 contacts the boundary portion between the cylindrical portion 21 and the contact portion 22 of the conductive member 2. As a result, the board 1 is held by the first retaining portions 32 and the second retaining portion 33.

The terminal 3 of the seventh embodiment achieves identical effects to the terminal 3 of the first embodiment.

### Eighth Embodiment

An eighth embodiment of the present invention will be described below. FIG. 8 is a cross-sectional view illustrating a state where a terminal related to the eighth embodiment is assembled to the board.

In the eighth embodiment, a modified structure of the second retaining portion 33 according to the first embodiment will be described. The identical reference numerals denote identical or corresponding parts of the first embodiment, and detailed explanation of those will be omitted.

As illustrated in FIG. 8, plural second retaining portions 33 (preferably, more than three second detent portions 33) equally spaced away from each other is provided on the body portion 31 in the circumferential direction thereof. Further, each of the second retaining portions 33 is formed with a swelled portion outwardly swelling in the perpendicular direction Y. A swelled height of each of the second retaining portions 33 is set to have sufficient height so that each of the second retaining portions 33 contacts the reverse surface 13 of the board 1, more specifically the boundary portion between the cylindrical portion 21 and the contact portion 22 of the conductive member 2, when the terminal 3 is assembled to the board 1. As a result, the board 1 is held by the first retaining portions 33 and the second retaining portions 33.

The terminal 3 of the eighth embodiment achieves identical effects to the terminal 3 of the first embodiment.

### Ninth Embodiment

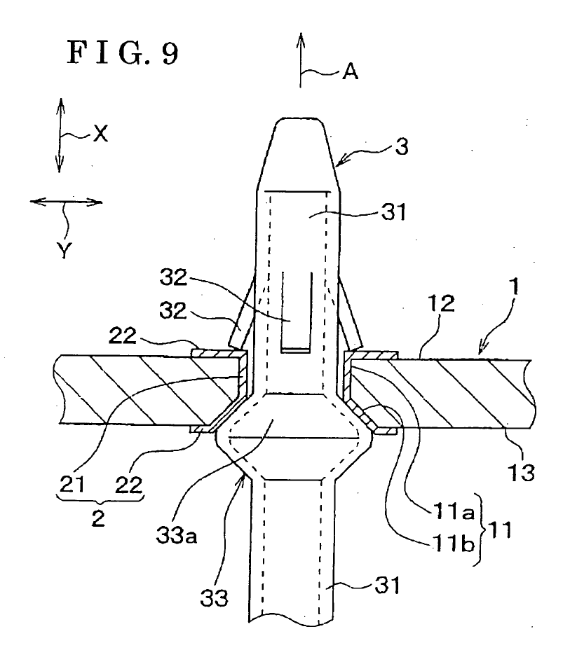

A ninth embodiment of the present invention will be described below. FIG. 9 is a cross-sectional view illustrating a state where a terminal related to the ninth embodiment is assembled to the board.

In the ninth embodiment, modified structures of the second retaining portion 33 and the board 1 according to the first embodiment will be described. The identical reference numerals denote identical or corresponding parts of the first embodiment, and detailed explanation of those will be omitted.

As illustrated in FIG. 9, a through-hole 11 of a board 1 includes a cylindrical through-hole portion 11a formed in a cylinder shape and a countersunk portion 11b. The cylindrical through-hole portion 11a is formed at the through-hole 11 at an exit side thereof in the insertion direction A. The countersunk portion 11b is formed at the entrance side when the terminal 3 is inserted thereinto, and further, an inner diameter of the countersunk portion 11b is enlarged towards the entrance side. More specifically, the countersunk potion 11b is enlarged from the exit side towards the entrance side in a conical manner.

A second retaining portion 33 of the terminal 3 includes a conical terminal portion 33a being enlarged towards the counter-insertion end. A taper angle of the conical terminal portion 33a is set to be equal to a taper angle of the countersunk portion 11b of the board 1.

The conical terminal portion 33a of the second retaining portion 33 contacts the countersunk portion 11b of the board 1. As a result, the board 1 is held by the first retaining portions 32 and the second retaining portion 33.

According to the ninth embodiment, the board 1 and the terminal 3 contact each other via its surfaces (i.e., in a flush manner), instead of points or lines. Hence, contact area between the board 1 and the terminal 3 may be enlarged in order to apply a large current.

### Tenth Embodiment

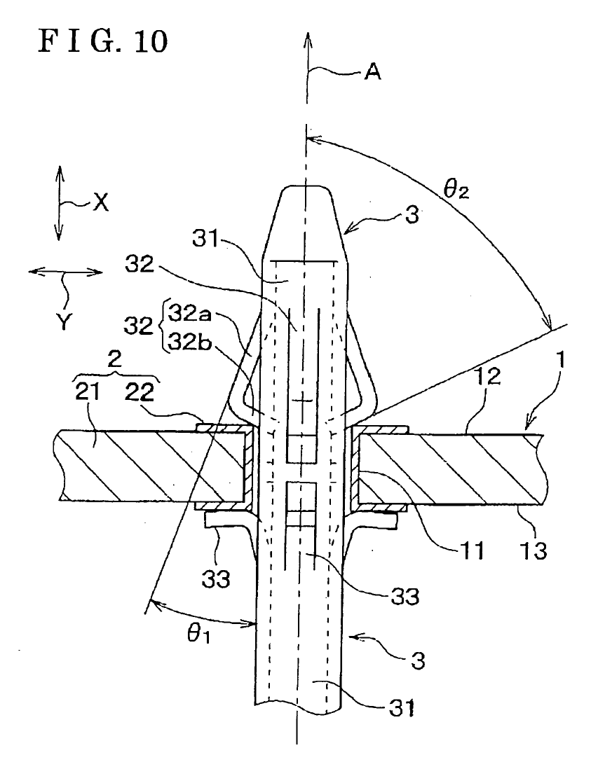

A tenth embodiment of the present invention will be described below. FIG. 10 is a cross-sectional view illustrating a state where a terminal related to the ninth embodiment is assembled to the board.

In the tenth embodiment, modified structures of the first retaining portions 32 and the second retaining portion 33 and the board 1 according to the first embodiment will be described. In addition, a second retaining portion 33 of the tenth embodiment has the same structure as the second retaining portion 33 of the fifth embodiment. The identical reference numerals denote identical or corresponding parts of the first and the fifth embodiments, and detailed explanation of those will be omitted.

As illustrated in FIG. 10, a first retaining portion 32 of the terminal 3 is made of a plate spring integrally formed with the body portion 31. More specifically, the first retaining portion 32 includes a free end at one side thereof in order to form a protruding piece. In particular, the first retaining portion 32 extends along the axial direction X of the body portion 31. Further, the first retaining portion 32 includes a fixed end connected to the body portion 31 at the insertion end side and a free end at the counter-insertion end side. The free end of the first retaining portion 32 is spaced away from the body portion 31. Further, the first retaining portion 32 is outwardly bent at the fixed end in the perpendicular direction Y. Moreover, the first retaining portion 32 is inwardly bent in the perpendicular direction Y at an intermediate portion of the first retaining portion 32 in the axial direction X. As a result, the intermediate portion of the first retaining portion 32 outwardly protrudes from the body portion 31 in the perpendicular direction, and the free end of the first retaining portion 32 is positioned inwardly relative to the intermediate portion in the perpendicular direction Y.

A first bent portion 32a, extending from the fixed end to the intermediate portion of each of first retaining portion 32, is outwardly inclined in the perpendicular direction Y towards the free end. A bending angle θ1 of each of the first bent portion 32a relative to the axial direction X is set to form an acute angle (for example, 15 to 20 degrees). A second bent portion 32b extending from the intermediate portion to the free end of the first retaining portion 32 is narrowed in the perpendicular direction Y towards the free end. A bending angle θ2 of the second bent portion 32b relative to the axial direction X is set to be larger than the bending angle θ1. For example, the bending angle θ2 is set to about 60 to 65 degrees. In the tenth embodiment, the body portion 31 includes four first retaining portions 32 that are equally spaced away from each other along the circumferential direction of the body portion 31.

According to the tenth embodiment, when the terminal 3 is inserted into the through-hope 11 of the board 1, the first retaining portions 32 are elastically deformed in the perpendicular direction Y, and then the terminal 3 proceeds through the cylindrical portion 21 with the first retaining portions 32 sliding the inner circumference of the cylindrical portion. After the first bent portion 32a of the first retaining portions 32 pass through the cylindrical portion 21, the first retaining portions 32 outwardly expand in the perpendicular direction Y by the resilience. As a result, the second bent portions 32b of the first retaining portions 32 engage with the obverse surface 12 of the board 1. More specifically, the second bent portions 32b contact the boundary portion between the cylindrical portion 21 and the contact portion 22 of the conductive member 2.

According to the tenth embodiment, after the terminal 3 is inserted into the through-hole 11 of the board 1, the second bent portions 32b engage with the boundary portion between the cylindrical portion 21 and the contact portion 22 of the conductive member 2. As a result, the terminal 3 is prevented from disengaging from the through-hole 11 of the board 1. According to the tenth embodiment, because the bending angle θ2 is set to be larger than the bending angle θ1, terminal 3 is easily inserted into the through-hole 11 of the board 1, and further, the terminal 3 is prevented from easily disengaging from the through-hole 11 of the board 1.

### Other Embodiments

According to the above-mentioned embodiments, the body portion 31 of the terminal 3 is formed in the cylinder-shape, in other words, a section of the body member 31 in the perpendicular direction Y is formed in a circular shape. However, the body portion 31 of the terminal 31 may be formed to have an angled cylinder-shape. In other words, the section of the body portion 31 in the perpendicular direction Y may be formed to have an angular shape.

According to the above-mentioned embodiments, the four first retaining portions 32 are provided at the body portion 31. However, the body portion 31 may be modified to include two first retaining portions 32. Similarly, in the embodiments where the body portion 31 includes the four first retaining portions 32 and four of the second retaining portions 33, the body portion 31 may be modified to include two first retaining portions 32 and two second retaining portions 33.

According to the embodiments, when the terminal 3 is inserted into the through-hole 11 of the board 1, the retaining portions 32 are elastically inwardly deformed in the perpendicular direction Y, and then the terminal 3 proceeds through the through-hole 11 with the first retaining portions 32 sliding the inner circumference of the through-hole 11. After the first retaining portions 32 pass through the through-hole 11, the first retaining portions 32 outwardly expand in the perpendicular direction Y by the resilience. Then, the first retaining portions 32 engage with the obverse surface 12 of the board 1 or with the boundary portion between the through-hole 11 and the obverse surface 12. As a result, the board 1 is held between the first retaining portions 32 and the second retaining portion(s) 33. Further, as a result, the terminal 3 is electrically connected with the board 1 at portions other than the inner circumference of the through-hole 11.

In the structure in which the conductive member 2 is provided on the inner circumference of the through-hole 11 or along the inner circumference thereof, the amount of the conductive member 2 being scratched off may be considerably decreased because the first retaining portions 32 are elastically deformed when proceeding through the through-hole 11, in other words, because the first retaining portions 32 do not generate as large pressing force as a case where the terminal 3 is press-fitted into the board 1.

Further, the stress generated at the board 1 may be decreased during and after the terminal 3 is assembled to the board 1.

Furthermore, the use of a press-in jig and the operation for inserting the press-in jig are eliminated. Hence, the number of components may be reduced, and further, the operation for inserting the press-fit jig may be eliminated.

The spring effects of the first retaining portions 32 may secure the current transmission between the terminal 3 and the conductive member 2. Further, a relative displacement (e.g., backlash) between the terminal 3 and the board 1 may be prevented.

According to the above-mentioned embodiments, each of the first retaining portion 32 includes the fixed end at the insertion end side for connecting the first retaining portion 32 and the body portion 31 and the free end at the counter-insertion end side, the free end is spaced away from the body portion 31 for forming the protruding piece and outwardly downwardly protrude from the body portion 31 in the perpendicular direction Y.

Accordingly, comparing to the case where the both ends of the first retaining portions 32 at the insertion end side and the counter-insertion end side are connected to the body portion 31, the first retaining portions 32 are easily elastically deformed. Hence, the terminal 3 easily passes through the through-hole 11 of the board 1. Further, after the terminal 3 is assembled to the board 1, the free ends of the first retaining portions 32 engage with the obverse surface 12 of the board 1 so that the terminal 3 is securely prevented from disengaging from the board 1.

According to the second embodiment, each of the first retaining portions 32 is provided between the two slits 34 being formed at the body portion 31 and extending in the axial direction X of the body portion 3 1, the both ends of each of the first retaining portions 32 at the insertion end side and the counter-insertion end side are connected to the body portion 31, and the intermediate portion of the first retaining portion 32 in the axial direction X outwardly protrudes from the body portion 31 in the perpendicular direction Y so as to form a clearance therebetween

Accordingly, the spring forces of the first retaining portions 32 may be set to any desired level by adjusting the length of the slits 34.

Further, the first retaining portions 32 contact with the conductive member 2 at the boundary portion (i.e., a corner portion) between the through-hole 11 and the obverse surface 12 of the board 1. Therefore, an area of the conductive member 2 provided in the vicinity of the through hole 11 on the obverse surface 12 may be decreased.

According to the tenth embodiment, each of the first retaining portions 32 includes the fixed end at the insertion end side for connecting the first retaining portion 32 and the body portion 31 and the free end at the counter-insertion end side spaced away from the body portion 31 for forming a protruding piece, each of the first retaining portions 32 is bent at a intermediate portion thereof in the axial direction X so that the intermediate portion outwardly protrudes from the body portion 31 in the perpendicular direction Y to form a clearance therebetween and so that the free end is positioned inwardly relative to the intermediate portion in the perpendicular direction Y.

Accordingly, comparing to the case where the both ends of the first retaining portions 32 at the insertion end side and the counter-insertion end side are connected to the body portion 31, the first retaining portions 32 are easily elastically deformed. Hence, the terminal 3 may easily pass through the through-hole 11 of the board 1. Further, after the terminal 3 is assembled to the board 1, the free ends of the first retaining portions 32 engage with the obverse surface 12 of the board 1 or the boundary portion between the through-hole 11 and the obverse surface 12. As a result, the terminal 3 is securely prevented from disengaging from the board 1.

According to the above-mentioned embodiments, a plurality of the first retaining portions 32 is provided at the body portion 31 in a circumferential direction thereof.

Accordingly, the current transmission between the conductive member 2 and the terminal 3 may be further secured. Moreover, the relative displacement between the terminal 3 and the board 1 may be further prevented.

According to the third and fourth embodiments, each of the second retaining portions 33 includes the fixed end at the insertion end side for connecting the second retaining portion 33 and the body portion 31 and the free end at the counter-insertion end side, the free end is spaced away from the body portion 31 for forming the protruding piece and outwardly protrudes from the body portion 31 in the perpendicular direction Y.

Accordingly, the free ends of the second retaining portions 33 engage with the reverse surface 13 of the board 1. As a result, the board 1 is securely held by the first retaining portions 32 and the second retaining portions 33.

Further, the spring effects of the second retaining portions 33 may secure the current transmission between the terminal 3 and the conductive member 2 on the reverse surface 13 in the vicinity of the through-hole 11. Moreover, the relative displacement (e.g., backlash) between the board 1 and the terminal 3 may be prevented.

According to the third embodiment, the conductive member 2 is provided at the board 1 so as to surround the openings of the through-hole 11, each of the second retaining portions 33 forms a curve shape from the fixed end to the free end thereof so that the second retaining portion 33 contacts the conductive member 2 at the boundary portion between the through-hole 11 and the second surface 13 of the board 1.

Accordingly, the area of the conductive member 2, which is extending along the reverse surface 13, in the vicinity of the through-hole 11 may be decreased.

According to the fourth embodiment, the conductive member 2 is provided at the board 1 so as to surround the openings of the through-hole 11, each of the second retaining portions 33 forms a curve shape from the fixed end to the free end thereof so that the second retaining portion 33 contacts the conductive member 2 extending on the second surface 13 other than the boundary portion between the through-hole 1 and the second surface 13 of the board 1.

Accordingly, because the entire second retaining portions 33 from its fixed ends to free ends are deformed, the concentration of the stress on the fixed portions may be prevented.

According to the fifth and tenth embodiments, each of the second retaining portions 33 includes the fixed end at the counter-insertion end side for connecting the second retaining portion 33 and the body portion 31 and the free end at an insertion end side, the free end is spaced away from the body portion 31 for forming a protruding piece and outwardly protrudes from the body portion 31 in the perpendicular direction Y.

Accordingly, the length of the second retaining portions 33 can be set to any desired length while avoiding contact with the first retaining portions 32. Hence, the spring forces of the second retaining portions 33 may be easily set to any desired level, and further, the second retaining portions 33 are easily modified so as to increase contact areas between the second retaining portions 33 and the conductive member 2.

According to the sixth embodiment, each of the second retaining portions 33 is provided between the two slits 35 being formed on the body portion 31 and extending in the axial direction X thereof, the both ends of the second retaining portion 33 at the insertion end side and the counter-insertion end side are connected to the body portion, and the intermediate portion of the second retaining portion 33 in the axial direction X outwardly protrudes from the body portion 31 in the perpendicular direction Y so as to form a clearance therebetween

Accordingly, the spring forces of the second retaining portions 33 may be set to any desired level by adjusting the length of the slits 35.

Further, the area of the conductive member 2 extending along the reverse surface 13 in the vicinity of the through-hole 11 may be decreased because the second retaining portions 33 contact the conductive member 2 at the boundary portion between the through-hole 11 and the reverse surface 13.

According to the third through sixth and ninth embodiments, a plurality of the second retaining portions 33 is provided at the body portion 31 in a circumferential direction thereof.

Accordingly, the current transmission between the terminal 3 and the conductive member 2 may be further secured, and the relative displacement between the board 1 and the terminal 3 may be further securely prevented.

According to the first, second, seventh and ninth embodiments, the second retaining portion 33 is formed by enlarging the body portion 31 from an insertion end side to the counter-insertion end side in the conical manner

Accordingly, the terminal 3 has the second retaining portion 33 having a stronger rigidity compared to the terminal 3 having the second retaining portions 33 each of which is formed between the two slits 35 and has the free end on one side thereof in order to form the protruding piece. Hence, even when the board 1 is pressed with a large force towards the second retaining portion 33, the terminal 3 may securely hold the board 1. In other words, the second retaining portions 33 may securely receive the terminal 1 even if a large force is applied thereto towards the second retaining portion 33.

Furthermore, the area of the conductive member 2 extending along the reverse surface 13 in vicinity of the through-hole 11 may be decreased because the second retaining portion 33 contacts the conductive member 2 at the boundary portion between the through-hole 11 and the reverse surface 13 of the board 1.

According to the eighth embodiment, a plurality of the second retaining portions 33 is provided at the body portion 31 in the circumferential direction thereof, and each of the second retaining portions 33 is formed with the swelled portion outwardly swelling in the perpendicular direction Y.

Accordingly, the terminal 3 has the second retaining portions 33 having stronger rigidity compared to the terminal 3 having the second retaining portions 33 each of which is formed between the two slits 35 and has the free end on one side thereof in order to form a protruding piece. Hence, even when the board 1 is pressed with a large force towards the second retaining portion 33, the terminal 3 securely hold the board 1. In other words, the second retaining portions 33 securely receives the terminal 1 even if the large force is applied thereto towards the second retaining portion 33.

Further, the area of the conductive member 2 extending along the reverse surface 13 in vicinity of the through-hole 11 may be decreased because the second retaining portions 33 contact the conductive member 2 at the boundary portion between the through-hole 11 and the reverse surface 13 of the board 1.

According to the above-mentioned embodiments, the section of the body portion 31 in the perpendicular direction Y is formed in the circular shape.

According to the other embodiments, the section of the body portion 31 in the perpendicular direction Y is formed in the angular shape.

According to the above-mentioned embodiments, the body portion 31 is freely retained within the through-hole 11.

Accordingly, the stress is prevented from occurring on the inner circumference of the through-hole 11 after the terminal 3 is assembled to the board 1. Therefore, the stress generated at the board I may be decreased.

According to the above-mentioned embodiments, at least one of the first retaining portion 32 and the second retaining portion 33 is a plate spring integrally formed with the body portion 31.

Accordingly, increase in the number of the components may be prevented.

Accordingly, the board 1 and the terminal 3 contact each other via surfaces. More specifically, the board 1 and the terminal 3 contact each other in a manner where the countersunk portion 11b is flush with the conical terminal portion 33a. Hence, a large current may be applied by enlarging the contact surface.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the sprit of the present invention. Accordingly, it is expressly intended that all such variations, changes and equivalents which fall within the spirit and scope of the present invention as defined in the claims, be embraced thereby.

1. A terminal adapted to be inserted into a through-hole of a board from an insertion end and electrically connected to the board, comprising:
a body portion in a cylindrical shape;
a first retaining portion outwardly extending from the body portion so as to be elastically deformable in a perpendicular direction relative to an axial direction of the body portion and contacting a first surface of the board or a boundary portion between the first surface and the through-hole; and
a second retaining portion positioned at a counter-insertion end side relative to the first retaining portion, outwardly protruding from the body portion and contacting a second surface, which is an opposite surface of the first surface, or a boundary portion between the second surface and the through-hole.

2. The terminal according to claim 1 wherein the first retaining portion includes a fixed end at an insertion end side for connecting the first retaining portion and the body portion and a free end at the counter-insertion end side, the free end is spaced away from the body portion for forming a protruding piece and outwardly protrudes from the body portion in the perpendicular direction.

3. The terminal according to claim 1 wherein the first retaining portion is provided between two slits being formed at the body portion and extending in the axial direction of the body portion, both ends of the first retaining portion at an insertion end side and the counter-insertion end side are connected to the body portion, and a intermediate portion of the first retaining portion in the axial direction outwardly protrudes from the body portion in the perpendicular direction so as to form a clearance therebetween.

4. The terminal according to claim 1 wherein the first retaining portion includes a fixed end at an insertion end side for connecting the first retaining portion and the body portion and a free end at the counter-insertion end side spaced away from the body portion for forming a protruding piece, the first retaining portion is bent at a intermediate portion thereof in the axial direction so that the intermediate portion outwardly protrudes from the body portion in the perpendicular direction to form a clearance therebetween and so that the free end is positioned inwardly relative to the intermediate portion in the perpendicular direction.

5. The terminal according to claim 1 wherein a plurality of the first retaining portions is provided at the body portion in a circumferential direction thereof.

6. The terminal according to claim 1 wherein the second retaining portion includes a fixed end at an insertion end side for connecting the second retaining portion and the body portion and a free end at the counter-insertion end side, the free end is spaced away from the body portion for forming a protruding piece and outwardly protrudes from the body portion in the perpendicular direction.

7. The terminal according to claim 6 wherein a conductive member is provided at the board so as to surround openings of the through-hole, the second retaining portion forms a curve shape from the fixed end to the free end thereof so that the second retaining portion contacts the conductive member at the boundary portion between the through-hole and the second surface of the board.

8. The terminal according to claim 6 wherein a conductive member is provided at the board so as to surround openings of the through-hole, the second retaining portion forms a curve shape from the fixed end to the free end thereof so that the second retaining portion contacts the conductive member extending on the second surface other than the boundary portion between the through-hole and the second surface of the board.

9. The terminal according to claim 1 wherein the second retaining portion includes a fixed end at the counter-insertion end side for connecting the second retaining portion and the body portion and a free end at an insertion end side, the free end is spaced away from the body portion for forming a protruding piece and outwardly protrudes from the body portion in the perpendicular direction.

10. The terminal according to claim 1 wherein the second retaining portion is provided between two slits being formed on the body portion and extending in the axial direction thereof, both ends of the second retaining portion at an insertion end side and the counter-insertion end side are connected to the body portion, and a intermediate portion of the second retaining portion in the axial direction outwardly protrudes from the body portion in the perpendicular direction so as to form a clearance therebetween.

11. The terminal according to claim 1 wherein a plurality of the second retaining portions is provided at the body portion in a circumferential direction thereof.

12. The terminal according to claim 1 wherein the second retaining portion is formed by enlarging the body portion from an insertion end side to the counter-insertion end side in a conical in manner.

13. The terminal according to claim 1 wherein a plurality of the second retaining portions is provided at the body portion in a circumferential direction thereof, and each of the second retaining portions is formed with a swelled portion outwardly swelling in the perpendicular direction.

14. The terminal according to claim 1 wherein a section of the body portion in the perpendicular direction is formed in a circular shape.

15. The terminal according to claim 1 wherein a section of the body portion in the perpendicular direction is formed in an angular shape.

16. The terminal according to claim 1 wherein the body portion is freely retained within the through-hole.

17. The terminal according to claim 1 wherein at least one of the first retaining portion and the second retaining portion is a plate spring integrally formed with the body portion.

18. A connecting structure between a terminal and a board comprising:
a board having a through-hole and a conductive member provided at an inner surface of the through-hole;
a terminal inserted into the through-hole from an insertion end and electrically connected to the conductive member;
a countersunk portion formed on the through-hole at an entrance side into which the terminal inserted and having an inner diameter increasing towards the entrance side, wherein the terminal includes a first retaining portion outwardly extending from the body portion so as to be elastically deformable in a perpendicular direction relative to an axial direction of the body portion and contacting a first surface of the board or a boundary portion between the first surface of the board opposite from the second to which the entrance is formed, and a conical terminal portion positioned at a counter-insertion end side relative to the first retaining portion and enlarged from the insertion end to the counter-insertion end in a conical manner and contacting the countersunk portion at their surfaces.
